(19) United States
(12) Patent Application Publication
(10) Pub. No.: US 2021/0319265 A1
(43) Pub. Date: Oct. 14, 2021

(54) Method for segmentation of underground drainage pipeline defects based on full convolutional neural network

(71) Applicants: Zhengzhou University, Zhengzhou (CN); BeSTDR Infrastructure Hospital(Pingyu), Zhumadian (CN)

(72) Inventors: Hongyuan Fang, Zhengzhou City (CN); Niannian Wang, Zhengzhou City (CN); Qunfang Hu, Zhumadian (CN); Binghan Xue, Zhumadian (CN); Xueming Du, Zhumadian (CN); Fan Huang, Zhumadian (CN)

(73) Assignees: Zhengzhou University; BeSTDR Infrastructure Hospital(Pingyu)

(21) Appl. No.: 17/356,533

(22) Filed: Jun. 24, 2021

(30) Foreign Application Priority Data
Nov. 2, 2020 (CN) 202011203831.0

(51) Int. Cl. G06K 9/62; G06N 3/08

(52) U.S. Cl. CPC G06K 9/6261; G06K 9/6265; G06N 3/08; G06K 9/6256; G06K 9/6232

(57) ABSTRACT

A method for segmentation of underground drainage pipeline defects based on full convolutional neural network includes steps of: collecting a data set of the underground drainage pipeline defects; processing the data set of the underground drainage pipeline defects; optimizing with a semantic segmentation algorithm; adjusting model hyperparameters; training a model; verifying the model; and testing the model. The method adopts a deep learning algorithm, optimizes the FCN full convolutional neural network, develops a semantic segmentation method suitable for complex and similar defect characteristics of underground drainage pipelines, and adopts real underground drainage pipeline defect detection big data, thereby realizing pixel-level segmentation of the underground drainage pipeline defects and providing better robustness and generality. The detection accuracy and efficiency of the underground drainage pipeline defects are effectively improved.

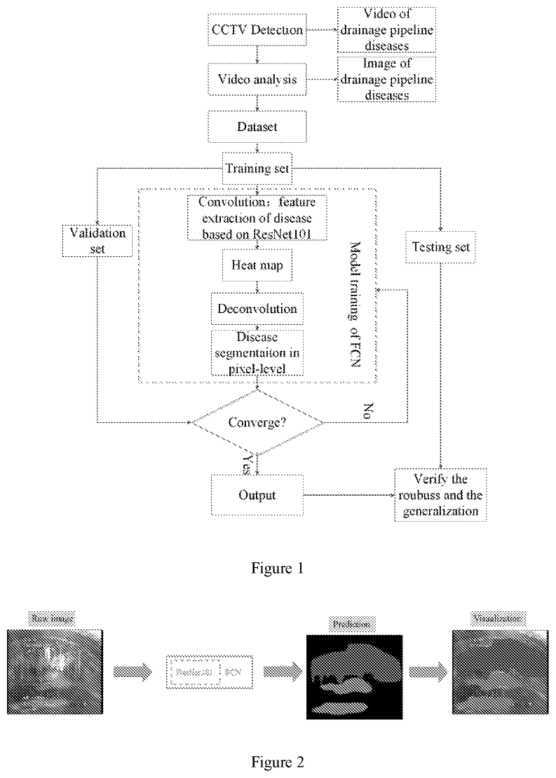

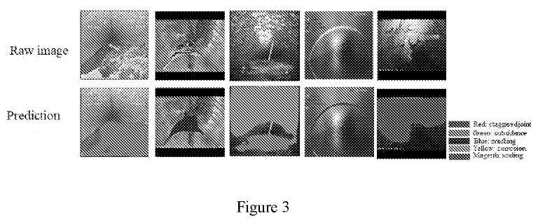

### CROSS REFERENCE OF RELATED APPLICATION

The present invention claims priority under 35 U.S.C. 119(a-d) to CN 202011203831.0, filed Nov. 2, 2020.

### BACKGROUND OF THE PRESENT INVENTION

### Field of Invention

The present invention relates to an interdisciplinary technical field of deep learning and underground pipe gallery engineering, and more particularly to a method for segmentation of underground drainage pipeline defects based on a full convolutional neural network.

### Description of Related Arts

In recent years, the potential safety hazards caused by the aging and disrepair of underground drainage pipelines have become prominent. Defects such as leakage, cracking, corrosion and subsidence are widespread, causing frequent accidents including environmental pollution, urban waterlogging, and road collapses, which seriously affect the daily life of residents, and even cause heavy casualties and economic losses. Therefore, the routine inspection and detection of typical pipeline defects are of great significance to the repair, reinforcement, safe operation and maintenance of underground pipelines.

However, the urban drainage pipeline network is an underground concealed project with extremely complex operating environment and geological conditions, and detection thereof is difficult. Conventionally, the main methods for detection of underground drainage pipeline include: manual observation, pipeline sonar detection, pipeline closed-circuit television detection (CCTV), etc. According to the manual observation method, professional inspection personnel should enter the pipeline for inspecting. Such method can directly inspect the internal conditions of the pipeline and the results are accurate. However, a toxic gas, hydrogen sulfide, often exists in the pipeline, which is likely to cause casualties to the inspectors. The pipeline sonar detection method detects cross sectional diameter, sediment shapes and corresponding deformation ranges of the pipeline based on ultrasonic wave. Such method can identify functional defects such as siltation and structural defects such as disconnection and deformation without interrupting water flow, but cannot detect pipeline corrosion, leakage and other defects. According to the CCTV method, a crawler equipped with a camera will enter the pipeline to capture internal images, and the technicians on the ground analyze the video recording to distinguish various pipeline structure and functional defects and their degrees. Although such method is currently the most widely used pipeline non-destructive inspection technology, there are some problems in the CCTV detection process: the defect is determined by technicians through video recording, which has a large workload and a low efficiency; the analysis of defect degree is greatly affected by personal experience, and it cannot provide quantitative indicators of defect damage degree, which is easy to produce errors.

### SUMMARY OF THE PRESENT INVENTION

In view of the shortcomings of the prior art, the present invention provides a method for segmentation of underground drainage pipeline defects based on a full convolutional neural network, so as to solve problems such as low accuracy and low efficiency, poor robustness and poor generality during detection of underground drainage pipeline defects in the prior art.

Accordingly, in order to accomplish the above objects, the present invention provides:

a method for segmentation of underground drainage pipeline defects based on a full convolutional neural network, comprising steps of:

S10: collecting a data set of the underground drainage pipeline defects, specifically comprising: using a pipeline robot to acquire a pipeline CCTV (closed-circuit television) defect detection video; extracting underground drainage pipeline defect images once every 30 frames from the defect detection video, and classifying acquired underground drainage pipeline defect image big data; selecting underground drainage pipeline defect images with typical defect characteristics;

S20: processing the data set of the underground drainage pipeline defects, specifically comprising: based on the underground drainage pipeline defect images with the typical defect characteristics obtained in the step S10, classifying and labeling pipeline defects with an open-source deep learning data labeling tool labelme, and establishing an underground drainage pipeline defect image database which is divided into a training set, a verification set and a test set in proportion;

S30: optimizing a semantic segmentation algorithm, specifically comprising: based on an FCN (full convolutional network) algorithm widely used for semantic segmentation, developing a semantic segmentation architecture for complex and similar defects of an underground drainage pipeline;

S40: adjusting model hyperparameters, specifically comprising: since the network learning rate has a greater impact on the training accuracy of the network model, setting different training learning rates to train a network model, and analyzing a loss, a pixel accuracy, and an average intersection ratio of a trained network model to find the model hyperparameters with a best training effect;

S50: training a model, specifically comprising: selecting a ResNet101 neural network based on residual learning units as a defect feature extraction network of the underground drainage pipeline, and using a migration learning method to perform model training according to the model hyperparameters adjusted in the step S40, so as to finally obtain a network model with optimized training and verifying accuracy;

S60: verifying the model, specifically comprising: based on the network model optimized in the step S50, verifying performance thereof with images of the verification set; analyzing difference between true defect areas of the verification set and predicted defect areas, and outputting various evaluation indicators to verify the performance of the optimized network model; and

S70: testing the model, specifically comprising: based on the network model optimized in the step S50, selecting images not involved in network model training and verification, so as to verify universality and generality of the network model; analyzing model test results, and evaluating the performance of the trained network model.

Preferably, the step S10 comprises specific steps of:

S11: collecting images of pavement defects by: using a CCTV pipeline detection robot to collect videos of the underground drainage pipeline defects on site;

S12: using a matlab program to extract images once every 30 frames from the collected videos of the underground drainage pipeline defects, and obtaining the underground drainage pipeline defect image big data; and

S13: screening the underground drainage pipe defect image big data acquired in the step S12, and selecting the underground drainage pipeline images with the typical defect characteristics as the data set of the underground drainage pipeline defects for deep learning and training.

Preferably, the typical defect characteristics of the underground drainage pipeline defects selected in the step S13 comprises misalignment, deposition, cracking, corrosion and scaling.

Preferably, the step S20 comprises specific steps of:

S21: classifying and labeling various defects in the underground drainage pipeline defect image big data as misalignment, deposition, cracking, corrosion and scaling with the open-source labeling tool labelme; wherein background area pixels are labeled as 0, misalignment area pixels are labeled as 1, deposition area pixels are labeled as 2, cracking area pixels are labeled as 3, corrosion area pixels are labeled as 4, and scaling area pixels are labeled as 5;

S22: combining binary label data (.png files) generated after calibration and original defect images (.jpg files) to establish the underground drainage pipeline defect image database; and

S23: using a matlab random classification program to divide the underground drainage pipeline defect image database into the training set, the verification set, and the test set in the proportion of 6:2:2.

Preferably, images of the training set, the verification set, and the test set in the step S23 have no overlap, and data of the test set are not involved in the network model training, which is conducive to verifying robustness and generality of the model.

Preferably, the step S30 comprises specific steps of:

S31: adopting the FCN framework, which comprises a full convolution part and a deconvolution part; replacing a last fully connected layer of the full convolution part with a 1*1 convolution layer; up-sampling a feature map of the deconvolution part corresponding to the full convolution part, so as to generate original-sized semantic segmentation images; and

S32: since the underground drainage pipeline defects are complex and similar, optimizing an FCN network layer to improve detection accuracy of the underground drainage pipeline defects.

Preferably, the step S40 comprises specific steps of: setting different initial learning rates, and training the network model using a mini-batch gradient descent method; observing the loss, the pixel accuracy, and the average intersection ratio of the trained network model to find the model hyperparameters with the best training effect.

Preferably, in the step S50, the ResNet101 neural network is selected as an FCN partial feature extraction network to generate a defect heat map; based on the migration learning method, initializing a network with a pre-trained weight model when sample data are less than a certain value, thereby accelerating the network model training and improving network model accuracy when the sample data are less than the certain value.

Preferably, in the step S60, the evaluation indicators to verify the performance of the trained network model comprise the pixel accuracy, a PR curve, and an average cross-to-parallel ratio.

Preferably, in the step S70, the images not involved in the network model training and the verification are selected as testing images which are used to evaluate the generality and robustness of the network model.

The present invention provides the method for segmentation of the underground drainage pipe defects based on the full convolutional neural network. Compared with the prior art, the method has at least the following beneficial effects:

The present invention adopts the full convolutional neural network framework to perform semantic segmentation of complex and similar defects in underground drainage pipelines, which realizes pixel-level detection and segmentation of pipeline defects, and solves the problems of misjudgment and omission in manual pipeline defect detection, thereby improving the accuracy of pipeline defect detection. The ResNet101 network with pre-trained weights is used as the feature extraction network for the full convolutional part of the full convolutional neural network, which increases utilization rate of defect features, so as to describe the pipeline defect features in more detail. The migration learning technology used can solve the problem of poor training accuracy of data samples, thereby improving the speed of model training and the accuracy of defect detection. Deep learning is combined with machine vision. Therefore, through training with a large number of underground drainage pipeline defects, the model can automatically learn complex and similar defect characteristics of the pipeline. Furthermore, the model can realize detection and judgment of pipeline defects at pixel-level, and can accurately segment and locate topological structures of drainage pipeline defects.

### BRIEF DESCRIPTION OF THE DRAWINGS

In order to explain the present invention more clearly, the drawing involved in the embodiment will be briefly introduced below. Obviously, the drawing in the following description only shows part of the embodiments of the present invention. To those skilled in the art, other drawings can be obtained based on the described drawing without creative work.

FIGURE is a flow chart of a method for segmentation of underground drainage pipe defects based on a full convolutional neural network according to the present invention.

### DETAILED DESCRIPTION OF THE PREFERRED EMBODIMENT

In order to facilitate the understanding, the present invention will be further described with reference to the relevant drawing. An embodiment of the present invention is shown in the drawing. However, the present invention can be implemented in many different forms and is not limited to the embodiment described herein. On the contrary, the purpose of the embodiment is to illustrate the present invention more clearly and comprehensively.

Unless otherwise defined, all technical and scientific terms used herein have the same meaning as commonly understood by those skilled in the art of the present invention. The terms used in the description of the present invention herein are only for the purpose of describing the embodiment, and are not intended to be limiting.

Referring to FIGURE, the present invention provides a method for segmentation of underground drainage pipeline defects based on a full convolutional neural network, comprising steps as follows.

S10: collecting a data set of the underground drainage pipeline defects: acquiring an underground drainage pipeline defect detection video; processing the acquired video to obtain underground drainage pipeline defect images with typical defect characteristics.

The step S10 comprises specific steps of:

S11: acquiring the underground drainage pipeline defect detection video by: using a pipeline detection robot to collect CCTV videos of the underground drainage pipeline defects;

S12: using a matlab program to extract images once every 30 frames from the collected videos of the underground drainage pipeline defects; and

S13: classifying the acquired underground drainage pipeline defect image big data, and selecting the underground drainage pipeline images with the typical defect characteristics with professionals.

Specifically, the main basis for selecting the images comprises:

the defect characteristics of the drainage pipeline in the image must be clear and intuitive, and visible to human eyes;

the image should contain five types of typical defects: misalignment, deposition, cracking, corrosion, and scaling;

the image should be diverse, which means there are images containing one type of defect, and images containing multiple types of defects;

the image should contain multiple types of external noise to increase the robustness of the network model, wherein the external noise comprises interference factors such as strong light, dark light, and debris; and

viewing angles of the image should be diversified, such as distant view, close view, front view, side view, etc.

S20: processing the data set of the underground drainage pipeline defects: based on the underground drainage pipeline defect images obtained in the step S10, classifying and labeling pipeline defects with a deep learning data labeling tool, and establishing an underground drainage pipeline defect image database comprising a training set, a verification set and a test set.

The step S20 comprises specific steps of:

S21: classifying and labeling various defects as misalignment, deposition, cracking, corrosion and scaling with an open-source labeling tool Labelme; wherein background area pixels are labeled as 0, misalignment (CK) area pixels are labeled as 1, deposition (CJ) area pixels are labeled as 2, cracking (PL) area pixels are labeled as 3, corrosion (FS) area pixels are labeled as 4, and scaling (JG) area pixels are labeled as 5;

S22: combining binary label data (.png files) generated after calibration and original defect images (.jpg files) to establish the underground drainage pipeline defect image database; and

S23: using a matlab random classification program to divide the underground drainage pipeline defect image database into the training set, the verification set, and the test set in the proportion of 6:2:2.

Specifically, the present invention uses the Labelme labeling tool to accurately label along defect boundaries. During labeling, the professional should carefully check all the defects in the images to improve the accuracy of the network training model. Finally, the labeling is completed to generate a binary drainage pipeline defect label map.

S30: optimizing a semantic segmentation algorithm, specifically comprising: based on an FCN (full convolutional network) algorithm widely used for semantic segmentation, developing a semantic segmentation architecture for complex and similar defects of an underground drainage pipeline.

The step S30 comprises specific steps of:

S31: adopting the FCN framework, which comprises a full convolution part and a deconvolution part; replacing a last fully connected layer of the full convolution part with a 1*1 convolution layer; up-sampling a feature map of the deconvolution part corresponding to the full convolution part, so as to generate original-sized semantic segmentation images; and

S32: since the underground drainage pipeline defects are complex and similar, optimizing an FCN network layer to improve detection accuracy of the underground drainage pipeline defects.

Specifically, a classic convolutional neural network (CNN) uses a fully connected layer after a convolutional layer to output feature vectors with a fixed size for classification (using fully connected layer+softmax layer). Because of a large storage cost of CNN, computational efficiency is relatively low, and it is unable to classify input images at pixel-level. Therefore, the present invention adopts the full convolutional neural network, and uses the deconvolution layer to up-sample the feature map of the last convolutional layer in the network, so that the feature map is restored to the same size of the input image. Then each pixel in the image is predicted and spatial information of the original image is preserved, so as to classify the defect pixel by pixel on the up-sampled feature map.

Specifically, the defect features extracted in the convolution process can generate a heat map, but the size of the heat map is small. In order to obtain dense pixel prediction of the original image size, the present invention performs up-sampling on the network, wherein predictions of the last layer are combined with predictions of a shallower layer by adding a skip structure, so as to perform local predictions while observing global predictions. First, a bottom layer prediction (FCN-32s) is processed with 2× up-sampling to obtain the original sized image which is then merged with a prediction from a pool4 layer. Then this part of prediction is again processed with 2× up-sampling and merged with the prediction from the pool3 layer, so as to further describe the defect features extracted by the network and improve prediction accuracy.

Specifically, in order to achieve a better deconvolution effect, the present invention uses maximum pooling instead of average pooling. The maximum pooling uses a maximum value in adjacent rectangular areas to replace an output of the network at that position, which can reduce mean shift caused by convolutional layer parameter errors, and preserve more texture information of the defect. Furthermore, global average pooling with a convolution kernel size of 2*2 is used instead of maximum pooling in the 14th layer, so as to process the entire network with regularization, and prevent over-fitting during the network model training.

S40: adjusting model hyperparameters, specifically comprising: since the network learning rate has a greater impact on the training accuracy of the network model, setting different training learning rates to train a network model, and analyzing a loss, a pixel accuracy, and MIoU of a trained network model to find the model hyperparameters with a best training effect.

Specifically, the main hyperparameter to be adjusted is the initial learning rate. The initial learning rate not only affects the speed of network model training, but also affects the convergence and detection accuracy of the network model;

Preferably, the main basis for adjusting the hyperparameters according to the embodiment is to set different initial learning rates (5×10⁻⁵, 1×10⁻⁵, and 2×10⁻⁵) to train the network model to observe change curves of the trained model such as the loss, the pixel accuracy, and the MioU. The network model, whose training loss curve tends to be stable and minimized while the network model pixel accuracy and MioU curve maximized and tends to be stable, is selected as the optimal solution.

Preferably, the embodiment has been tuned many times, and the final hyperparameters of the trained model are: the initial learning rate is 1×10⁻⁵, a momentum coefficient is 0.99, a weight attenuation value is 0.0005, a number of small batch images in each iteration is 2, and a total number of iterations is 100,000.

S50: training a model, specifically comprising: selecting a neural network based on residual learning units as a defect feature extraction network of the underground drainage pipeline, and using a migration learning method to perform model training according to the model hyperparameters adjusted in the step S40, so as to finally obtain a network model with optimized training and verifying accuracy.

Specifically, based on the migration learning method, a network is initialized with a pre-trained weight model when sample data are less than a certain value, thereby accelerating the network model training and improving network model accuracy when the sample data are less than the certain value.

Specifically, during the network model training for the classic neural network, as a network depth increases, the gradient spatial structure is eliminated, which causes the problem of network degradation. The present invention adopts the ResNet101 neural network as an FCN partial feature extraction network to generate a defect heat map. The network is composed of a series of residual learning units, wherein through “Shortcut Connection”, forward and backward propagations of defect feature information are smoother, thereby increasing a utilization rate of low-level network defect features, and improving the accuracy of defect detection.

S60: verifying the model, specifically comprising: based on the network model optimized in the step S50, verifying performance thereof with images of the verification set; analyzing difference between true defect areas of the verification set and predicted defect areas, and outputting various evaluation indicators to verify the performance of the optimized network model.

Specifically, the evaluation indicators to verify the performance of the trained network model comprise the pixel accuracy (PA), a PR curve, and an average cross-to-parallel ratio (MIoU). Calculation formulas are as follows:

$$P A = \frac{{\sum }_{u = 0}^{k} {p}_{uu}}{{\sum }_{u = 0}^{k} {\sum }_{v = 0}^{k} {p}_{uv}}$$

$$MIoU = \frac{1}{k + 1} {\sum }_{u = 0}^{k} \frac{{p}_{uu}}{{\sum }_{v = 0}^{k} {p}_{uv} + {Σ}_{v = 0}^{k} {p}_{vu} - {p}_{uu}}$$

wherein k is a quantity of defect types, pᵤᵥ is a quantity of pixels where the network model regards a type u defect as a type v defect, pᵤᵤ represents true positives, pᵤᵥ and pᵥᵤ represent false positive and false negative, respectively.

S70: testing the model, specifically comprising: based on the network model optimized in the step S50, selecting images not involved in network model training and verification, so as to verify detection, universality and generality of the optimized network model; analyzing model test results, and evaluating the performance of the trained network model.

Preferably, selection of the test images is classified as:

the image has a single type of the drainage pipeline defects, which is used to verify the detection effect of the trained network model on single defect;

the image has multiple types of the drainage pipeline defects, which further tests the generality of the network model for detecting multiple types of defects; and

the image has a variety of external environmental noises such as strong light, dark light, and multiple shooting angles to test the robustness of the network model.

According to the above embodiment, the method for segmentation of the underground drainage pipeline defects based on the full convolutional neural network adopts the full convolutional neural network framework to perform semantic segmentation of complex and similar defects in underground drainage pipelines, which realizes pixel-level detection and segmentation of pipeline defects, and solves the problems of misjudgment and omission in manual pipeline defect detection, thereby improving the accuracy of pipeline defect detection. The ResNet101 network with pre-trained weights is used as the feature extraction network for the fully convolutional part of the fully convolutional neural network, which increases utilization rate of defect features, so as to describe the pipeline defect features in more detail. The migration learning technology used can solve the problem of poor training accuracy of data samples, thereby improving the speed of model training and the accuracy of defect detection; The deep learning is combined with machine vision. Therefore, through training with a large number of underground drainage pipeline defect characteristics, the model can automatically learn complex and similar defect characteristics of the pipeline. Furthermore, the model can realize detection and judgment of the pipeline defects at pixel-level, and can accurately segment and locate topological structures of drainage pipeline defects. As a result, the detection accuracy is improved, and development of underground drainage pipeline maintenance industry can be effectively promoted.

Obviously, the embodiment described above is only a preferred embodiment of the present invention, rather than all. The embodiment is shown in the drawing, which does not limit the patent scope of the present invention. The present invention can be implemented in many different forms. On the contrary, the purpose of the embodiment is to illustrate the present invention more clearly and comprehensively. Although the present invention has been described in detail with reference to the foregoing embodiment, those skilled in the art can still modify the technical solutions described in the foregoing embodiment, or equivalently replace some of the technical features. Any equivalent structure made by using the contents of the specification and drawing of the present invention, directly or indirectly used in other related technical fields, is similarly within the protection scope of the present invention.

What is claimed is:

1. A method for segmentation of underground drainage pipeline defects based on a full convolutional neural network, comprising steps of:
S10: collecting a data set of the underground drainage pipeline defects, specifically comprising: using a pipeline robot to acquire a pipeline CCTV (closed-circuit television) defect detection video; extracting underground drainage pipeline defect images once every 30 frames from the defect detection video, and classifying acquired underground drainage pipeline defect image big data; selecting underground drainage pipeline defect images with typical defect characteristics;
S20: processing the data set of the underground drainage pipeline defects, specifically comprising: based on the underground drainage pipeline defect images with the typical defect characteristics obtained in the step S10, classifying and labeling pipeline defects with an open-source deep learning data labeling tool labelme, and establishing an underground drainage pipeline defect image database which is divided into a training set, a verification set and a test set in proportion;
S30: optimizing a semantic segmentation algorithm, specifically comprising: based on an FCN (full convolutional network) algorithm widely used for semantic segmentation, developing a semantic segmentation architecture for complex and similar defects of an underground drainage pipeline;
S40: adjusting model hyperparameters, specifically comprising: setting different training learning rates to train a network model, and analyzing a loss, a pixel accuracy, and an average intersection ratio of a trained network model to find the model hyperparameters with a best training effect;
S50: training a model, specifically comprising: selecting a ResNet101 neural network based on residual learning units as a defect feature extraction network of the underground drainage pipeline, and using a migration learning method to perform model training according to the model hyperparameters adjusted in the step S40, so as to finally obtain a network model with optimized training and verifying accuracy;
S60: verifying the model, specifically comprising: based on the network model optimized in the step S50, verifying performance thereof with images of the verification set; analyzing difference between true defect areas of the verification set and predicted defect areas, and outputting various evaluation indicators to verify the performance of the optimized network model; and
S70: testing the model, specifically comprising: based on the network model optimized in the step S50, selecting images not involved in network model training and verification, so as to verify universality and generality of the network model; analyzing model test results, and evaluating the performance of the trained network model.

2. The method, as recited in claim 1, wherein the step S10 comprises specific steps of:
S11: collecting images of pavement defects by: using a CCTV pipeline detection robot to collect videos of the underground drainage pipeline defects on site;
S12: using a matlab program to extract images once every 30 frames from the collected videos of the underground drainage pipeline defects, and obtaining the underground drainage pipeline defect image big data; and
S13: screening the underground drainage pipe defect image big data acquired in the step S12, and selecting the underground drainage pipeline images with the typical defect characteristics as the data set of the underground drainage pipeline defects for deep learning and training.

3. The method, as recited in claim 2, wherein the typical defect characteristics of the underground drainage pipeline defects selected in the step S13 comprises misalignment, deposition, cracking, corrosion and scaling.

4. The method, as recited in claim 1, wherein the step S20 comprises specific steps of:
S21: classifying and labeling various defects in the underground drainage pipeline defect image big data as misalignment, deposition, cracking, corrosion and scaling with the open-source labeling tool labelme; wherein background area pixels are labeled as 0, misalignment area pixels are labeled as 1, deposition area pixels are labeled as 2, cracking area pixels are labeled as 3, corrosion area pixels are labeled as 4, and scaling area pixels are labeled as 5;
S22: combining binary label data generated after calibration and original defect images to establish the underground drainage pipeline defect image database; and
S23: using a matlab random classification program to divide the underground drainage pipeline defect image database into the training set, the verification set, and the test set in the proportion of 6:2:2.

5. The method, as recited in claim 4, wherein images of the training set, the verification set, and the test set in the step S23 have no overlap, and data of the test set are not involved in the network model training.

6. The method, as recited in claim 1, wherein the step S30 comprises specific steps of:
S31: adopting the FCN framework, which comprises a full convolution part and a deconvolution part; replacing a last fully connected layer of the full convolution part with a 1*1 convolution layer; up-sampling a feature map of the deconvolution part corresponding to the full convolution part, so as to generate original-sized semantic segmentation images; and
S32: since the underground drainage pipeline defects are complex and similar, optimizing an FCN network layer to improve detection accuracy of the underground drainage pipeline defects.

7. The method, as recited in claim 1, wherein the step S40 comprises specific steps of: setting different initial learning rates, and training the network model using a mini-batch gradient descent method; observing the loss, the pixel accuracy, and the average intersection ratio of the trained network model to find the model hyperparameters with the best training effect.

8. The method, as recited in claim 1, wherein in the step S50, the ResNet101 neural network is selected as an FCN partial feature extraction network to generate a defect heat map; based on the migration learning method, initializing a network with a pre-trained weight model when sample data are less than a certain value, thereby accelerating the network model training and improving network model accuracy when the sample data are less than the certain value.

9. The method, as recited in claim 1, wherein in the step S60, the evaluation indicators to verify the performance of the trained network model comprise the pixel accuracy, a PR curve, and an average cross-to-parallel ratio.

10. The method, as recited in claim 1, wherein in the step S70, the images not involved in the network model training and the verification are selected as testing images which are used to evaluate the generality and robustness of the network model.
